(19) United States
(12) Patent Application Publication
(10) Pub. No.: US 2022/0325575 A1
(43) Pub. Date: Oct. 13, 2022

(54) FOLDABLE SHEER SHADE

(71) Applicant: LI-MING CHENG, Kaohsiung City (TW)

(72) Inventor: LI-MING CHENG, Kaohsiung City (TW)

(21) Appl. No.: 17/228,830

(22) Filed: Apr. 13, 2021

(51) Int. Cl. E06B 9/322; E06B 9/262; E06B 9/60; E06B 9/323

(52) U.S. Cl. CPC E06B 9/322; E06B 9/262; E06B 9/60; E06B 9/323; E06B 2009/2627

(57) ABSTRACT

A foldable sheer shade includes a supporting seat, a controlling module, a shade, and a receiving device. The controlling module is disposed to the supporting seat and includes a coiling rod. The shade has an end connected to the coiling rod. The shade includes a plurality of hollow portions arranged in an axial direction. The receiving device includes a box and a limiting member coupled to the box. The limiting member extends through one of the plurality of hollow portions of the shade. A portion of the shade below the limiting member is coiled to be received in a receiving space of the box and is positioned by the limiting member.

### BACKGROUND OF THE INVENTION

### 1. Field of the Invention

The present invention relates to a foldable shade and, more particularly, to a foldable sheer shade.

### 2. Description of the Related Art

In modern interior arrangement of home, collocation of various window shades is necessary for controlling the light or creating a special atmosphere. Sheer shades have the advantages of cloth and yarn as well as the functions of venetian blinds, coilable shades, and Roman shades. Furthermore, the light shielding effect of sheer shades can be easily adjusted. Thus, sheer shades are being used more and more in interior arrangement of home.

A sheer shade can be cut to a proper length in response to the demands in various spaces or in response to personal preferences and styles as well as the decoration. However, considering the overall aesthetic after cutting and avoiding damage to the sheer shade due to improper cutting, a user often cannot cut the sheer shade by himself or herself Thus, the user must seek help from a special factory or a store, which is inconvenient in use.

In light of this, it is necessary to improve the conventional method for adjusting the length of a sheer shade.

### SUMMARY OF THE INVENTION

It is therefore an objective of the present invention to provide a foldable sheer shade permitting easy use and easy operation by a user to adjust a shade of the foldable sheer shade to a proper length.

It is another objective of the present invention to provide a foldable sheer shade with improved assembly convenience.

It is a further objective of the present invention to provide a foldable sheer shade with lower manufacturing costs.

It is yet another objective of the present invention to provide foldable sheer shade with improved operational smoothness.

As used herein, the term “a” or “an” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

As used herein, the term “coupling”, “engagement”, “assembly”, or similar terms is used to include separation of connected members without destroying the members after connection or inseparable connection of the members after connection. A person having ordinary skill in the art would be able to select according to desired demands in the material or assembly of the members to be connected.

The sheer shade of the present invention is also known as “Shangri-La shade”.

A foldable sheer shade according to the present invention includes a supporting seat, a controlling module, a shade, and a receiving device. The controlling module is disposed to the supporting seat and includes a coiling rod. The shade has an end connected to the coiling rod. The shade includes a plurality of hollow portions arranged in an axial direction. The receiving device includes a box and a limiting member coupled to the box. The limiting member extends through one of the plurality of hollow portions of the shade. A portion of the shade below the limiting member is coiled to be received in a receiving space of the box and is positioned by the limiting member.

Thus, in the foldable sheer shade according to the present invention, the limiting member can extend through one of the plurality of hollow portions of the shade, and the portion of the shade below the limiting member can be coiled to be received in the receiving space. Then, the limiting member is coupled to the box to position the shade, preventing the coiled portion from falling out of the receiving space. Thus, the user can easily adjust the shade to a proper length through simple operation, increasing the use convenience.

In an example, the box includes two channels, and two edges of the limiting member extend into the two channels to close an opening of the box. Thus, the coiled portion of the shade received in the receiving space is prevented from falling out via the opening, increasing the use convenience.

In an example, the box includes two resilient portions forming the two channels, respectively, and the limiting member presses against the two resilient portions to extend into the two channels. Thus, the structure is simple and easy to assemble, increasing the assembly convenience.

In an example, the controlling module includes a transmission unit and an elastic element. The transmission unit includes a first transmission wheel and a second transmission wheel. Two ends of the elastic element are coupled to the first transmission wheel and the second transmission wheel, respectively. Thus, the structure is simple and easy to be manufactured, reducing the manufacturing costs.

In an example, the elastic element is an S-shaped spring, a helical spring, or a coil spring. Thus, the elastic element is easy to be obtained, reducing the manufacturing costs.

In an example, the coiling rod includes a first end. The supporting seat includes a first cap having a first coupling portion. The first end of the coiling rod is rotatably coupled to the first coupling portion of the first cap. Thus, the structure is simple and easy to be manufactured, reducing the manufacturing costs.

In an example, the controlling module includes a transmission unit having a first transmission wheel, and the coiling rod includes a second end coupled to the first transmission wheel. Thus, the coiling rod can rotate jointly with the first transmission wheel, increasing the rotational smoothness.

In an example, the first transmission wheel includes a shaft, the second end of the coiling rod is coupled to the shaft. The shaft is in a form of a non-circular post. The second end of the coiling rod is in a form of a non-circular hole. Thus, relative rotation between the coiling rod and the first transmission wheel is prevented, increasing the rotational smoothness.

In an example, the portion of the shade below the limiting member is coiled towards the limiting member to form a coiled portion. The coiled portion and the receiving device together serve as a gravity balancing portion configured to be pushed or pulled by a user. Thus, the shade can be easily pushed upwards to a completely coiled state, increasing the use convenience.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is an exploded perspective view of a foldable sheer shade of an embodiment according to the present invention.

FIG. 2 is a partially exploded perspective view of a supporting seat and a controlling module of the foldable sheer shade of an embodiment according to the present invention.

FIG. 3 a partially exploded perspective view of a shade and a receiving device of the foldable sheer shade of an embodiment according to the present invention.

FIG. 4 is a cross-sectional view of the foldable sheer shade after assembly of an embodiment according to the present invention.

FIG. 5 is a diagrammatic view illustrating the operation of the foldable sheer shade according to the present invention as shown in FIG. 4.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

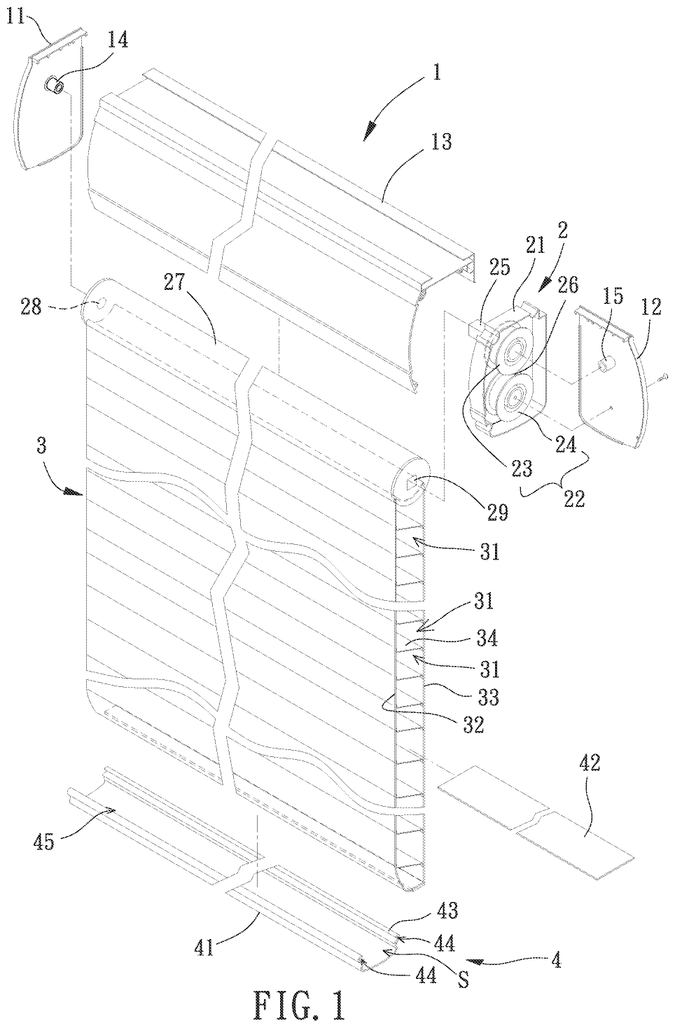

With reference to FIG. 1, a foldable sheer shade of an embodiment according to the present invention includes a supporting seat 1, a controlling module 2, a shade 3, and a receiving device 4. The controlling module 2 is disposed to the supporting seat 1. An end of the shade 3 is connected to the controlling module 2. A portion of the shade 3 is coiled in the receiving device 4.

The supporting seat 1 can include a first cap 11 and a second cap 12 coupled to two ends of a frame 13 of the supporting seat 1, respectively. The first and second caps 11 and 12 are preferably made of non-metal material. In this embodiment, the first and second caps 11 and 12 are formed by plastic material to reduce the overall weight of the supporting seat 1.

The first cap 11 can include a first coupling portion 14 facing the second cap 12. The second cap 12 can include a second coupling portion 15 facing the first cap 11 and aligned with the first coupling portion 14. The forms of the first and second coupling portions 14 and 15 are not limited in the present invention nor should they be restricted by the forms shown in the figures of this embodiment. In this embodiment, each of the first and second coupling portions 14 and 15 is a post.

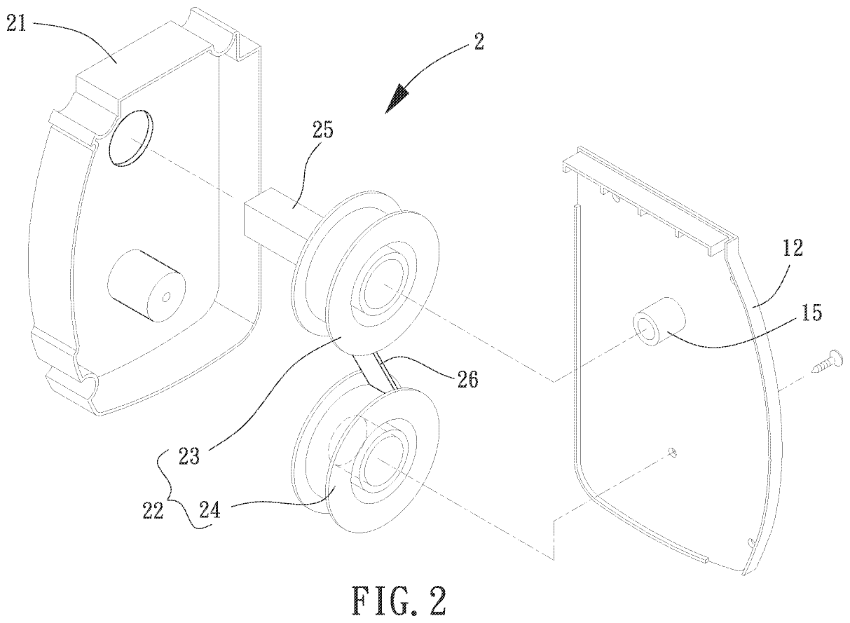

With reference to FIGS. 1 and 2, the controlling module 2 is coupled to the supporting seat 1 and includes a casing 21 and a transmission unit 22. The casing 21 can be adjacent to the first cap 11 or the second cap 12. In this embodiment, the casing 21 is adjacent to the second cap 12. Furthermore, the casing 21 is coupled to the second cap 12. The transmission unit 22 is received and fixed between the casing 21 and the second cap 12.

Specifically, the transmission unit 22 can include a first transmission wheel 23 and a second transmission wheel 24. The first transmission wheel 23 can include a shaft 25 extending away from the second cap 12. The shaft 25 is formed along a central axis and is preferably in the form of a non-circular post. Furthermore, the controlling module 2 can include an elastic element 26 having two ends coupled to the first and second transmission wheels 23 and 24 of the transmission unit 2, respectively. The elastic element 26 can have an elastic structure, such as an S-shaped spring, a helical spring, or a coil spring.

Furthermore, the controlling module 2 includes a coiling rod 27 having opposite first and second ends 28 and 29. The first end 28 can be in the form of a hole. The first end 28 is rotatably coupled with the first coupling portion 14 of the first cap 11, such that the coiling rod 27 can rotate relative to the first cap 11. The second end 29 is coupled with the shaft 25 of the first transmission wheel 23. The second end 29 can be in the form of a non-circular hole for coupling with the shaft 25. Thus, the shaft 25 is driven to rotate when the coiling rod 27 rotates and vice versa, permitting joint rotation of the coiling rod 27 and the shaft 25.

With reference to FIG. 1, the shade 3 is coiled around the coiling rod 27 of the controlling module 2. An end of the shade 3 can be fixed to the coiling rod 27. The shade 3 and the coiling rod 27 can rotate jointly, permitting the shade 3 to be coiled upwards or extended downwards by pulling. The shade 3 can include a two-layer structure to provide a light adjusting function. The shade 3 can include a plurality of hollow portions 31 arranged in an axial direction.

Specifically, the shade 3 can include a front board 32 and a rear board 33. The front board 32 and the rear board 33 are substantially parallel to each other and can be made of any suitable material, such as textiles, woven, nonwoven fabrics, etc. The shade 3 can further include a plurality of axially arranged separation boards 34 connected between the front and rear boards 32 and 33. The plurality of axially arranged separation boards 34 can also be made of any suitable material, such as textiles, woven, nonwoven fabrics, etc. A hollow portion 31 is formed between any two adjacent separation boards 34 and the front and rear boards 32 and 33. The plurality of axially arranged separation boards 34 can be connected between the front and rear boards 32 and 33 by any suitable means, such as sewing, adhesives, fasteners, etc. The present invention is not limited in this regard. When the shade 3 is extended, the relative position between the front and rear boards 32 and 33 can be adjusted, such that the plurality of separation boards 34 can tilt to control the light passing through the shade 3 according to needs.

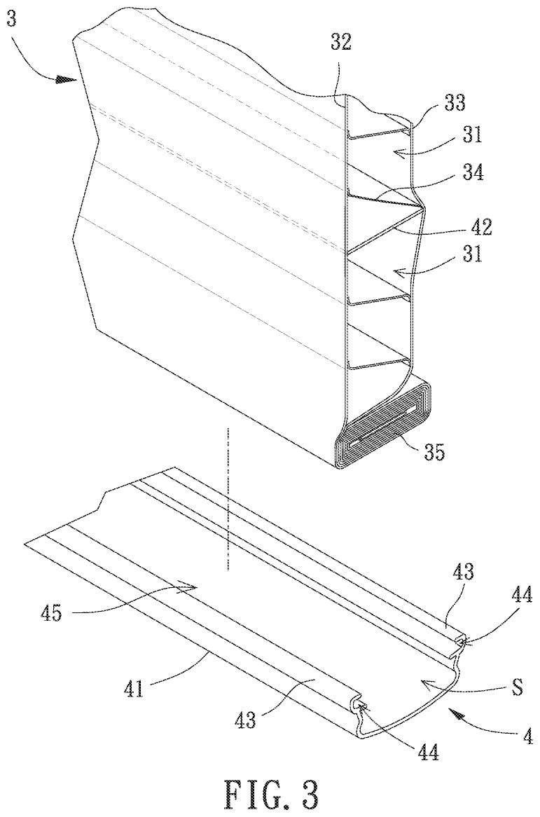

With reference to FIGS. 1 and 3, the receiving device 4 includes a box 41 and a limiting member 42 coupled to the box 41. A portion of the shade 3 can be coiled and received in a receiving space S of the box 41. Specifically, the box 41 can be substantially U-shaped and have two resilient portions 43 forming two channels 44, respectively. Furthermore, an opening 45 is formed between the two resilient portions 43 and intercommunicates with the receiving space S. The opening 45 can face the coiling rod 27 of the controlling module 2.

Furthermore, the limiting member 42 can extend through one of the plurality of hollow portions 31 of the shade 3. The form of the limiting member 42 is not limited in the present invention as long as it is configured to close the opening 45 of the box 41. In this embodiment, the limiting member 42 is in the form of a plate that can press against the two resilient portions 43 of the box 41 from above, such that two edges of the limiting member 42 can enter the two channels 44.

With reference to FIGS. 1, 3, and 4, when it is desired to adjust the shade 3 to a proper length, the limiting member 42 extends through one of the plurality of hollow portions 31 of the shade 3, as shown in FIG. 3, and the portion of the shade 3 below the limiting member 42 is coiled towards the limiting member 42 to form a coiled portion 35 that can be adjacent to the limiting member 42. Then, the coiled portion 35 is placed into the receiving space S. The limiting member 42 presses against the two resilient portions 43 of the box 41 from above, such that two edges of the limiting member 42 extend into the two channels 44 to close the opening 45. Thus, the coiled portion 35 is positioned in the receiving space S, preventing the coiled portion 35 from falling out via the opening 45. As a result, a user can easily adjust the shade 3 to a proper length through simple operation, increasing the use convenience.

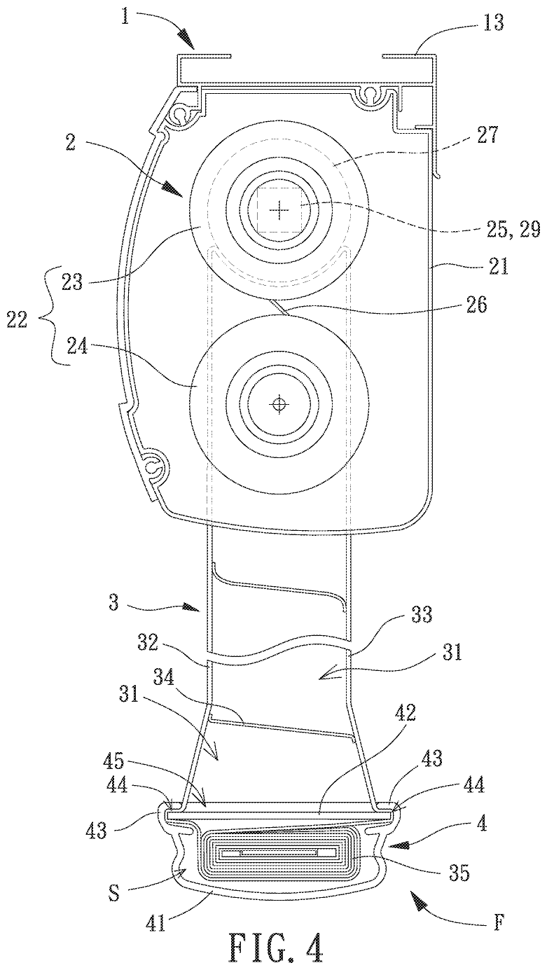

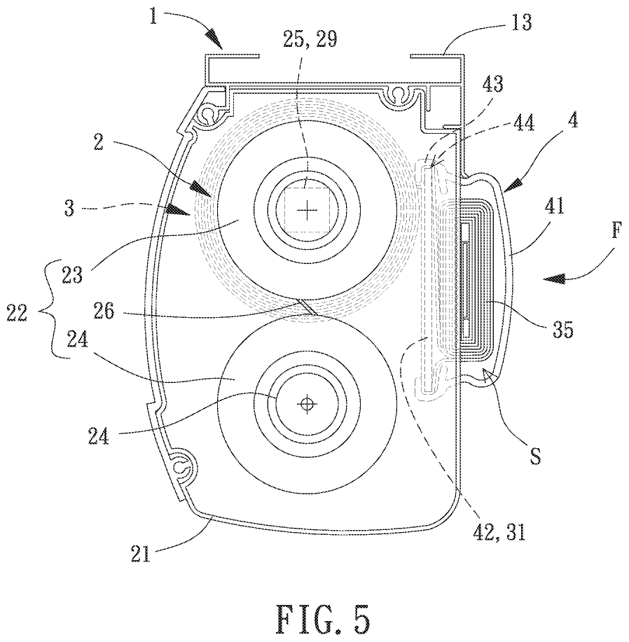

With reference to FIGS. 4 and 5, the coiled portion 35 and the receiving device 4 together serve as a gravity balancing portion F like weights. The gravity balancing portion F can be pushed or pulled by a user. Specifically, when it is not necessary to block the light by the shade 3, the user can pull the shade 3 downwards by the gravity balancing portion F. On the other hand, the user can push the gravity balancing portion F to counterbalance the pulling force resulting from the weight of the gravity balancing portion F. Thus, the weight of the gravity balancing portion F no longer creates a torque on the coiling rod 27. In this case, the elastic restoring force from the elastic element 26 of the controlling module 2 still creates a torque on the first transmission wheel 23, thereby driving the first transmission wheel 23 to rotate the coiling rod 27. Thus, the shade 3 can be easily pushed upwards to the coiled state, such that the shade 3 can be in a fully coiled state shown in FIG. 5.

In view of the foregoing, in the foldable sheer shade according to the present invention, the limiting member can extend through one of the plurality of hollow portions of the shade, and the portion of the shade below the limiting member can be coiled to be received in the receiving space. Then, the limiting member is coupled to the box to position the shade, preventing the coiled portion from falling out of the receiving space. Thus, the user can easily adjust the shade to a proper length through simple operation, increasing the use convenience.

Although the invention has been described in detail with reference to its presently preferable embodiments, it will be understood by one of ordinary skill in the art that various modifications can be made without departing from the spirit and the scope of the invention, as set forth in the appended claims

What is claimed is:

1. A foldable sheer shade comprising:
a supporting seat;
a controlling module disposed to the supporting seat and including a coiling rod;
a shade having an end connected to the coiling rod, wherein the shade including a plurality of hollow portions arranged in an axial direction; and
a receiving device including a box and a limiting member coupled to the box, wherein the limiting member extends through one of the plurality of hollow portions of the shade, and wherein a portion of the shade below the limiting member is coiled to be received in a receiving space of the box and is positioned by the limiting member.

2. The foldable sheer shade as claimed in claim 1, wherein the box includes two channels, and wherein two edges of the limiting member extend into the two channels to close an opening of the box.

3. The foldable sheer shade as claimed in claim 2, wherein the box includes two resilient portions forming the two channels, respectively, and wherein the limiting member presses against the two resilient portions to extend into the two channels.

4. The foldable sheer shade as claimed in claim 1, wherein the controlling module includes a transmission unit and an elastic element, wherein the transmission unit includes a first transmission wheel and a second transmission wheel, wherein two ends of the elastic element are coupled to the first transmission wheel and the second transmission wheel, respectively.

5. The foldable sheer shade as claimed in claim 4, wherein the elastic element is an S-shaped spring, a helical spring, or a coil spring.

6. The foldable sheer shade as claimed in claim 1, wherein the coiling rod includes a first end, wherein the supporting seat includes a first cap having a first coupling portion, and wherein the first end of the coiling rod is rotatably coupled to the first coupling portion of the first cap.

7. The foldable sheer shade as claimed in claim 1, wherein the controlling module includes a transmission unit having a first transmission wheel, and wherein the coiling rod includes a second end coupled to the first transmission wheel.

8. The foldable sheer shade as claimed in claim 7, wherein the first transmission wheel includes a shaft, wherein the second end of the coiling rod is coupled to the shaft, wherein the shaft is in a form of a non-circular post, and wherein the second end of the coiling rod is in a form of a non-circular hole.

9. The foldable sheer shade as claimed in claim 1, wherein the portion of the shade below the limiting member is coiled towards the limiting member to form a coiled portion, and wherein the coiled portion and the receiving device together serve as a gravity balancing portion configured to be pushed or pulled by a user.

10. The foldable sheer shade as claimed in claim 2, wherein the portion of the shade below the limiting member is coiled towards the limiting member to form a coiled portion, and wherein the coiled portion and the receiving device together serve as a gravity balancing portion configured to be pushed or pulled by a user.

11. The foldable sheer shade as claimed in claim 3, wherein the portion of the shade below the limiting member is coiled towards the limiting member to form a coiled portion, and wherein the coiled portion and the receiving device together serve as a gravity balancing portion configured to be pushed or pulled by a user.

12. The foldable sheer shade as claimed in claim 4, wherein the portion of the shade below the limiting member is coiled towards the limiting member to form a coiled portion, and wherein the coiled portion and the receiving device together serve as a gravity balancing portion configured to be pushed or pulled by a user.

13. The foldable sheer shade as claimed in claim 5, wherein the portion of the shade below the limiting member is coiled towards the limiting member to form a coiled portion, and wherein the coiled portion and the receiving device together serve as a gravity balancing portion configured to be pushed or pulled by a user.

14. The foldable sheer shade as claimed in claim 6, wherein the portion of the shade below the limiting member is coiled towards the limiting member to form a coiled portion, and wherein the coiled portion and the receiving device together serve as a gravity balancing portion configured to be pushed or pulled by a user.

15. The foldable sheer shade as claimed in claim 7, wherein the portion of the shade below the limiting member is coiled towards the limiting member to form a coiled portion, and wherein the coiled portion and the receiving device together serve as a gravity balancing portion configured to be pushed or pulled by a user.

16. The foldable sheer shade as claimed in claim 8, wherein the portion of the shade below the limiting member is coiled towards the limiting member to form a coiled portion, and wherein the coiled portion and the receiving device together serve as a gravity balancing portion configured to be pushed or pulled by a user.
